(19) United States
(12) Patent Application Publication
(10) Pub. No.: US 2003/0085790 A1
(43) Pub. Date: May 8, 2003

(54) Inductive micro-sensor formed flat on an integrated circuit

(75) Inventor: Pierre-Andre Farine, Neuchatel (CH)

Correspondence Address: SUGHRUE MION, PLLC, 2100 PENNSYLVANIA AVENUE, N.W., WASHINGTON, DC, 20037, US

(73) Assignee: ASULAB S.A.

(21) Appl. No.: 10/259,570

(22) Filed: Sep. 30, 2002

(30) Foreign Application Priority Data
Nov. 6, 2001 (EP) 01204214.9

(51) Int. Cl. H01F 27/28

(52) U.S. Cl. 336/225

(57) ABSTRACT

The inductive micro-sensor includes a flat micro-coil (2) formed on an integrated circuit (4) by long conductive segments Sᵢ with a high aspect ratio, each segment Sᵢ being arranged along a perpendicular direction with respect to the next segment Sᵢ₊₁ to form a spiral type structure with an overall square or rectangular contour. It is characterised in that each long segment Sᵢ is connected to the next long segment Sᵢ₊₁ by means of a short segment sᵢ forming, with the two long segments Sᵢ, Sᵢ₊₁, angles α and α′ greater than 90°.

The present invention concerns an inductive micro-sensor comprising a micro-coil formed flat on an integrated circuit and, more particularly, a micro-sensor of this type forming, with the integrated circuit, an inductive detection or measurement device.

Large sized induction coils, made by winding a conductive wire around a core having a diameter of the order of 30 to 50 mm have been used for a long time in the industry, for example for detecting the proximity of metal objects or defects in their appearance. These coils have first of all been used as a model for passing to smaller scale, with a diameter of the order of a millimetre. This miniaturisation allows these coils to be used in microsystems, for very numerous applications, for example for making inductive proximity sensors for counting parts, for security devices, or for slave control, such as the angular control of a stepping motor of a clockwork movement. These coils with wound wire allow a sufficiently high signal to be obtained, but the coil itself is still bulky which is a drawback in certain applications, in particular in the horological field where it is standard for all the movement components to have the lowest possible height and to occupy the smallest possible surface area.

In order to overcome the above drawback, these micro-coils were then made in flat form by shaping a conductive material on a substrate in accordance with known techniques for making the paths of a printed circuit. Quite naturally, the coil was formed by a chain of segments leading to a spiral type structure with a rectangular or square contour. According to the works published by Ph. A. Passeraub & col. (“Metallic profile and coin imaging using an inductive proximity sensor microsystem”, Sensors and Actuators A, Vol. 66 (1998), pp 225-230 and “First integrated inductive proximity sensor with on-chip CMOS read out circuit and electrodeposited 1 mm flat coil”, Sensors Series, Eurosensors XII, vol 1, Institute of Physics Publishing, Southampton, United Kingdom, 1998, pp 575-578), an inductance of 1.1 μH (Rₛ=2.5 Ω) with a wound wire coil comprising 23 turns and an inductance of 75 nH (Rₛ=6.2 Ω) with a 1 mm wide square flat coil comprising a winding with 10 turns 1 μm high and 20 μm wide. To compensate for this loss of inductance, various arrangements have been proposed for increasing the number of turns of a flat coil without increasing the surface occupied on the substrate. In a Japanese Patent Application published under No. JP 57050410, it is proposed to construct two windings of the above type by printing or electrodeposition, on either side of the substrate, these two windings being interconnected through the substrate. In U.S. Pat. No. 4,313,152, it is proposed to have, on the same side of the substrate, two windings that are superposed, interleaved and separated by an insulating material, i.e. rectangular turns situated alternately on either side of the insulating material with multiple interconnection bridges through the insulating material. Such constructions are evidently complex and ill suited to mass production.

With the progress made in electrodeposition techniques, one has naturally thought of increasing the height of the segments forming the square spiral type winding. As will be explained in more detail in the following description the results obtained are not totally satisfactory because of the scrap rate.

The object of the invention is thus to overcome the drawbacks of the aforecited prior art by providing a micro-sensor having a flat coil with a spiral type winding of square or rectangular contour, enabling quite a high inductance to be obtained, and able to be produced simply with a minimum of scrap.

The invention thus concerns an inductive micro-sensor comprising a flat micro-coil formed on an integrated circuit by long conductive segments with a high aspect ratio, each segment being arranged along a perpendicular direction with respect to the following segment to form a spiral type structure with an overall square or rectangular shape. The micro-coil is characterised in that each long segment is connected to the next long segment by means of a short segment forming angles α and α′ greater than 90° with the two segments.

The invention will be better understood upon reading the description hereinafter with reference to the annexed drawings, in which:

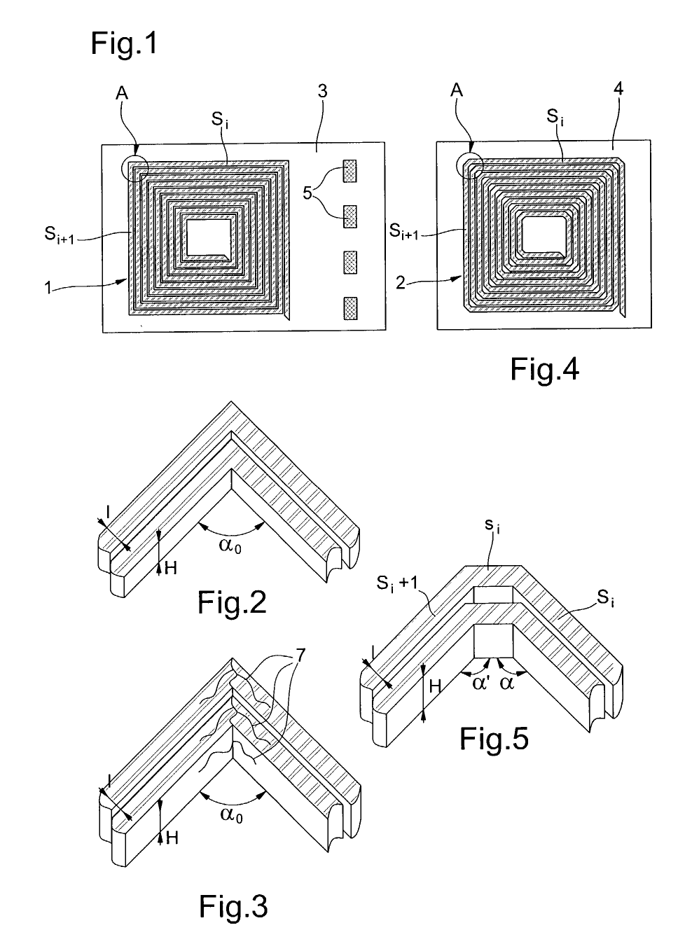

FIG. 1 is a top view of a micro-sensor according to the prior art;

FIG. 2 is an enlarged perspective diagram of an angle of the micro-sensor of FIG. 1 according to a first embodiment;

FIG. 3 is an enlarged perspective diagram of an angle of the micro-sensor of FIG. 1 according to a second embodiment;

FIG. 4 is a top view of a micro-sensor according to the invention, and

FIG. 5 is an enlarged perspective diagram of an angle of the micro-sensor of FIG. 4.

FIGS. 1 to 3 show an inductive micro-sensor of the prior art, for example for carrying out the angular detection of a wheel in a watch movement, as is described for example in European Patent No. EP 0 952 426. The micro-sensor is formed by a flat coil 1 arranged on the board 3 of a printed circuit (not shown) comprising contact pads 5 for transmitting signals, for example to a control unit. Flat coil 1 is formed by a spiral type winding with segments Sᵢ forming between them a right angle (α₀=90°). In the example shown, flat coil 1 comprises a winding with 10 “turns”. Segments Si of this winding are made by known techniques, such as screen printing or photolithography with electrodeposition. As shown in FIG. 2, the segments have a low aspect ratio (height over width ratio less than 1).

With a low aspect ratio (for example H=10μ and I=20μ) the right angled connection of one segment to another does not pose any particular problem, conversely, as indicated in the preamble, a big inductance reduction is observed with respect to a micro-coil of substantially the same base size but comprising a larger number of turns.

To reduce resistance and thus increase the sensitivity of the micro-sensor without increasing the surface occupied by the micro-coil and without using the complex solutions mentioned in the preamble, one can envisage increasing the section of segments Sᵢ, i.e. in fact their height H, as shown in FIG. 3. The advantage obtained as regards inductance is set off by the drawback that quite a high percentage of defective coils (evaluated at 20%) has to be set aside from the manufacturing batches, which is economically disadvantageous, and which is even more so when said coils are constructed directly on an integrated circuit which can no longer be reused if the micro-coil is defective. Indeed, when the aspect ratio is high (H/I>1) and segments are connected by forming an angle ≦90°, cracks 7 frequently appear at the connection.

With reference now to FIGS. 4 and 5 which show a micro-coil 2 formed flat on an integrated circuit 4, it can be seen that the above drawbacks are reduced, or even removed by “breaking” the connection angles of large segments Sᵢ by small segments sᵢ, i.e. by small portions approximately 10 to 30 times shorter than the large segments. Thus, the angle α formed between a large segment Sᵢ and a small segment sᵢ and the angle α′ formed by the small segment sᵢ and the next large segment Sᵢ₊₁ is greater than 90°. Since the winding is preferably regular, angle α is preferably equal to α′, i.e. 135° for all the connection zones of large segments Sᵢ.

This construction evidently slightly reduces the length of the winding but has almost negligible influence on the inductance decrease. By way of example, with a 1 mm wide square flat micro-coil, made in accordance with the prior art corresponding to FIGS. 1 and 3, comprising 10 “turns” with gold segments 20 μm wide and 30 μm high, the inductance is 75 nH and total resistance is 6.2 Ω. By making a micro-coil with the same features as above, but “breaking” the angles with small segments 50 μm long. No significant variation in inductance has been observed.

Segments Sᵢ and sᵢ can be achieved by known photolithography and electrodeposition techniques. They may also, and preferably, be made by the “bumping” technique consisting in depositing an additional layer of gold at the surface of the integrated circuit, in particular above the contact pad zones, or above the last insulation layer. Owing to the excellent conductibility of gold, this technique enables optimum interconnectivity to be obtained, as well as extremely low resistance values for structures made on the insulation layer of the integrated circuit.

What is claimed is:

1. A inductive micro-sensor including a flat micro-coil formed on an integrated circuit by long conductive segments Sᵢ with a high aspect ratio, each segment Sᵢ being arranged along a perpendicular direction with respect to the next segment Sᵢ₊₁ to form a spiral type structure with an overall square or rectangular contour, wherein each long segment Sᵢ is connected to the next long segment Sᵢ₊₁ by means of a short segment sᵢ forming, with the two long segments Sᵢ, Sᵢ₊₁, angles α and α′ greater than 90°.

2. The inductive micro-sensor according to claim 1, wherein the angles α and α′ are both equal to 135°.

3. The inductive micro-sensor according to claim 1, wherein the segments sᵢ are 10 to 30 times shorter than the long segments Sᵢ.

4. The inductive micro-sensor according to claim 3, wherein the segments Sᵢ, sᵢ of the micro-coil (2) are formed on the integrated circuit by bumping technology.
